(19) United States
(12) Patent Application Publication
(10) Pub. No.: US 2012/0203430 A1
(43) Pub. Date: Aug. 9, 2012

(54) ELECTRIC POWER STEERING SYSTEM

(75) Inventors: Yuichi Shimada, Saitama (JP); Kazuhiko Inaba, Saitama (JP); Taku Natsume, Saitama (JP); Masaya Kusatani, Saitama (JP); Masanori Takagi, Saitama (JP); Toshiharu Akashi, Saitama (JP); Kouji Nakamura, Saitama (JP); Akio Ueno, Tochigi (JP)

(73) Assignee: HONDA MOTOR CO., LTD., Tokyo (JP)

(21) Appl. No.: 13/501,233

(22) PCT Filed: Oct. 12, 2010
(86) PCT No.: PCT/JP2010/006056

§ 371 Date: Apr. 10, 2012

(30) Foreign Application Priority Data
Oct. 20, 2009 (JP) 2009-241002

(51) Int. Cl. B62D 6/02; B62D 6/06; B62D 6/04

(52) U.S. Cl. 701/41

(57) ABSTRACT

Electric power steering system comprises an electric motor (9) for producing a steering assist force reducing a steering effort of a vehicle operator and a control unit (21) determining a control value for the electric motor, the control unit being configured to determine the control value by selecting a map representing a relationship between a vehicle state variable and a control value for each of a plurality of control modes. When switching control modes, the control unit gradually changes the control value from that obtained from a map corresponding to a preceding control mode to that of a following control mode. A different time period of gradual transition from the preceding control mode to the following control mode is selected depending on those control modes.

### FIELD OF THE INVENTION

The present invention relates to an electric power steering system which is configured for a plurality of control modes corresponding to different steering properties and enabled to switch the control modes while the vehicle is in motion.

### BACKGROUND OF THE INVENTION

In a known automotive electric power steering system, by taking advantage of the fact that the steering property can be varied by adjusting the steering assist force which the electric motor provides for reducing the effort required to steer the vehicle, it was proposed to allow a selection between a normal mode corresponding to a standard steering property and a sports mode corresponding to a smaller steering assist force and hence a heavier steering effort. See Patent Document 1.

### PRIOR ART DOCUMENT(S)

### Patent Document(s)

Patent Document 1: JP 11-020727A

### BRIEF SUMMARY OF THE INVENTION

### Task to be Achieved by the Invention

In such an electric power steering system that allows the control modes to be switched, it is advantageous to allow the control modes to be switched when the vehicle is in motion according to the preference of the vehicle operator. The switch from one mode to another is typically carried out such that the control value is gradually changed from a value for one control mode to a value for another control mode. If this transition time period for changing the control value is too long, the vehicle operator is unable to appreciate the change in the control modes, and may not find this feature of the electric power steering system highly attractive. On the other hand, if this transition time period is too short, the vehicle operator may experience some discomfort.

The present invention was made in view of such a recognition by the inventors, and has a primary object to provide an electric power steering system that allows the vehicle operator to appreciate the changes in the control modes without causing any discomfort to the vehicle operator in any way.

### Means to Accomplish the Task

According to the present invention, such an object can be accomplished by providing an electric power steering system (1) comprising an electric motor (9) for producing a steering assist force for reducing a steering effort of a vehicle operator and a control unit (21: steering control unit) for determining a control value for the electric motor, the control unit being configured to determine the control value by selecting a map representing a relationship between a vehicle state variable and a control value for each of a plurality of control modes, characterized in that: when switching the control modes, the control unit gradually changes the control value from that obtained from a map corresponding to a preceding control mode to that obtained from a map corresponding to a following control mode, and a different time period of gradual transition from the preceding control mode to the following control mode is selected depending on the preceding and following control modes.

Because a different time period of gradual transition from the preceding control mode to the following control mode is selected depending on the preceding and following control modes, the vehicle operator is enabled to clearly sense the change in the control modes without causing discomfort to the vehicle operator.

According to a second aspect of the present invention, the plurality of control modes include at least a first control mode (normal mode) corresponding to a standard steering property and a second control mode (sports mode) corresponding to a heavier steering property than the first control mode, the transition time period from the second control mode to the first control mode being longer than the transition time period from the first control mode to the second control mode.

Because the transition time period from the first control mode to the second control mode is relative short, and the change in the steering property occurs immediately, the vehicle operator is enabled to sense the change in the control modes. Because the change involves a heavier steering property, even when the change is abrupt, the vehicle operator does not experience any unfamiliar impression. Conversely, because the transition time period from the second control mode to the first control mode is relative long, the steering property is avoided from being made suddenly lighter, and the discomfort of the vehicle operator can be thereby avoided.

According to a third aspect of the present invention, the control unit comprises computing units (the base current computing unit 31, the inertia compensation current computing unit 32 and the damping compensation current computing unit 33) for computing a base control value based on a steering force of a vehicle operator and a vehicle speed, an inertia compensation value based on an inertia of an associated steering system and a damping compensation value based on a damping factor of the associated steering system, and is configured to determine the control value from computation results of these computing units, at least one of the computing units being configured to select a different map for each of a plurality of control modes.

By compensating the base control value with the inertia compensation value, the response delay due to the inertia of the steering system can be improved so that a highly brisk steering impression may be achieved. By compensating the base control value with the damping compensation value, the rotation of the electric motor is controlled so that a stable steering impression can be achieved, and the stability of the vehicle may be ensured.

### Effect of the Invention

According to the present invention, because a different time period of gradual transition from the preceding control mode to the following control mode is selected depending on the preceding and following control modes, the vehicle operator is enabled to appreciate the changes in the control modes without causing any discomfort to the vehicle operator in any way.

### BRIEF DESCRIPTION OF THE SEVERAL VIEWS OF DRAWINGS

FIG. 1 is a diagram illustrating an electric power steering system embodying the present invention:

FIG. 2 is a functional block diagram showing the overall structure of a control system for the electric power steering system shown in FIG. 1; and

FIG. 3 is a timing chart showing the mode of operation of the electric power steering system shown in FIG. 1.

### DETAILED DESCRIPTION OF THE INVENTION

Now a preferred embodiment of the present invention is described in the following with reference to the appended drawings.

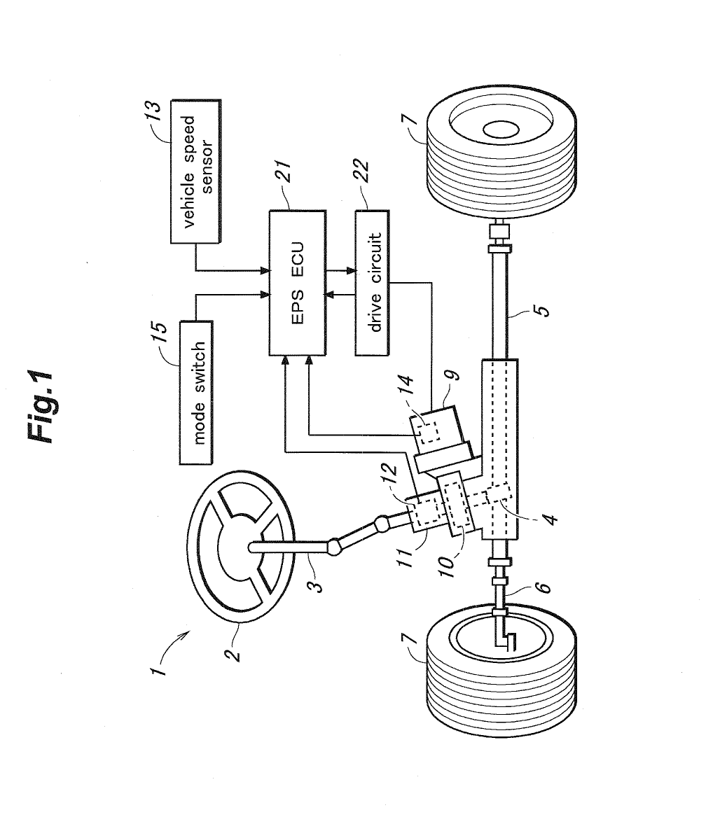

Referring to FIG. 1, the electric power steering system 1 embodying the present invention comprises a rack and pinion mechanism including a pinion 4 connected to a steering wheel 2 via a steering shaft 3 and a rack shaft 5 meshing with the pinion 4 and disposed so as to reciprocate in the lateral direction, and the two ends of the rack shaft 5 are connected to the left and right front wheels 7 serving as steerable wheels via tie rods 6, respectively, so that the front wheels 7 are steered in response to the angular movement of the steering wheel 2.

This electric power steering system 1 further comprises an electric motor 9 for generating a steering assist force for reducing the effort required for turning the steering wheel 2, and the drive force of the electric motor 9 is transmitted to the steering shaft 3 via a worm gear mechanism 10 received in a gear box 11 along with the pinion 4.

In the gear box 11 is provided a steering torque sensor 12 for detecting the steering torque that is applied to the pinion 4. A vehicle speed sensor 13 for detecting the traveling speed of the vehicle is provided in an appropriate part of the vehicle body. The electric motor 9 is incorporated with a resolver 14 for detecting the angular position of the electric motor 9. The output signals from the steering torque sensor 12, the vehicle speed sensor 13 and the resolver 14 are forwarded to a steering control device (EPS-ECU) 21 which comprehensively controls the operation of the electric power steering system 1.

The steering control device 21 comprises a microcomputer, ROM, RAM, peripheral circuits, an input interface, an output interface and various drivers, and determines a target current value (control value) for driving the electric motor 9 and forwards the same to a drive circuit 22 for the electric motor 9. The drive circuit 22 essentially consists of a FET bridge circuit that supplies electric power to the electric motor 9 according to the target current value determined by the steering control device 21 so as to control the output torque of the electric motor 9.

The steering control device 21 may be additionally provided with various functions such as the fail safe, self-diagnosis, motor output restriction and external diagnostic communication functions.

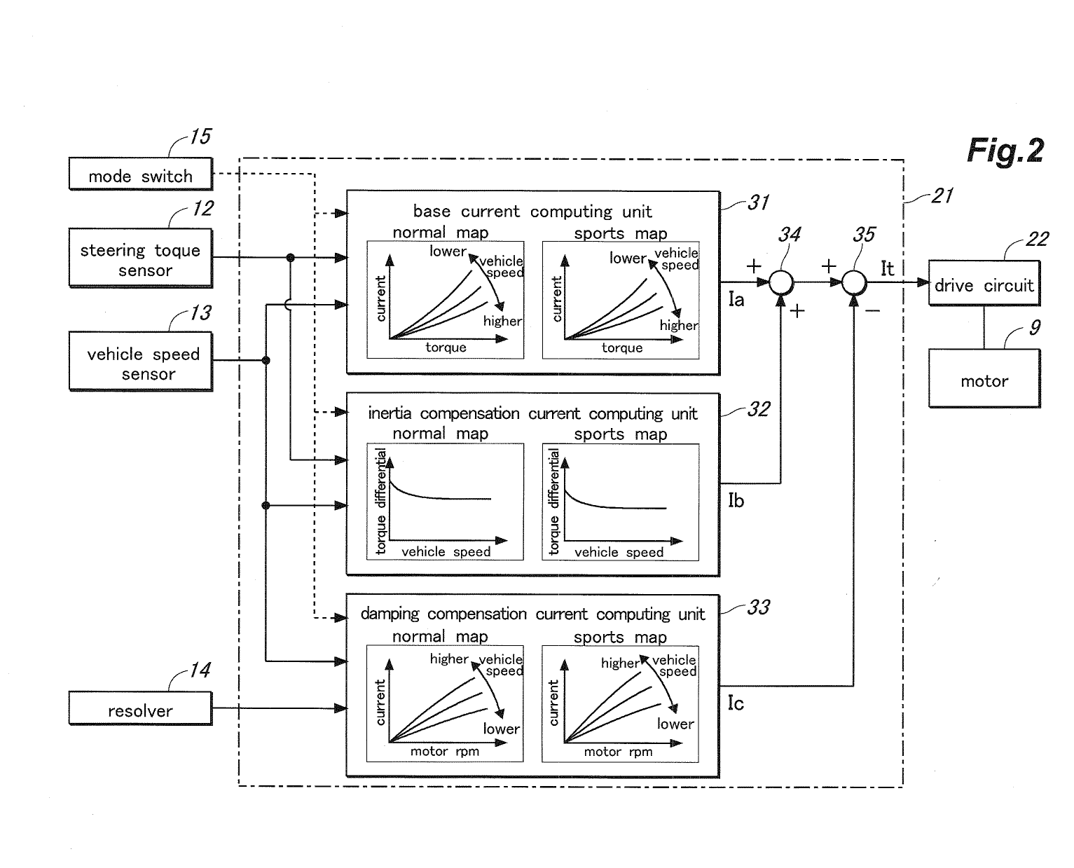

As shown in FIG. 2, the steering control device 21 comprises a base current computing unit 31, an inertia compensation current computing unit 32, a damping compensation current computing unit 33, an adder 34 and a subtractor 35. The various components of the steering control device 21 are realized by executing a computer program stored in memory by using a CPU.

The base current computing unit 31 computes a base current value Ia, which provides a basis for the target current value It, according to the steering torque provided by the steering torque sensor 12 and the vehicle speed provided by the vehicle speed sensor 13.

The inertia compensation current computing unit 32 is configured to compensate for the influences of the inertia in the steering system, and computes an inertia compensation current value Ib according to the time differential value of the steering torque provided by the steering torque sensor 12 and the vehicle speed provided by the vehicle speed sensor 13. The inertia compensation current value Ib is added to the base current value Ia at the adder 34 so that the response delay of the steering system owing to the inertia of the steering system is reduced, and a brisk response of the steering system is ensured.

The damping compensation current computing unit 33 is configured to compensate for the influences of the viscous damping effect in the steering system, and computes a damping compensation current value Ic from the rotational speed of the electric motor 9 obtained from the rotational angle of the electric motor 9 detected by the resolver 14 and the vehicle speed provided by the vehicle speed sensor 13. The damping compensation current value Ic is subtracted from the base current value Ia at the subtractor 35 so that a stable steering action may be ensured by appropriately controlling the rotation of the electric motor 9 and the stability of the vehicle behavior may be thereby ensured.

As the steering rotational speed of the steering wheel 2 is proportional to the rotational speed of the electric motor 9, the steering angular speed obtained by time differentiating the steering angle of the steering wheel 2 provided by the steering angle sensor may be used, instead of the rotational speed of the motor.

The base current computing unit 31, the inertia compensation current computing unit 32 and the damping compensation current computing unit 33 are each provided with a plurality of maps each representing a relationship between the corresponding state variable of the vehicle and the corresponding current value for the corresponding control mode. In this particular embodiment, a selection can be made between a normal mode (first control mode) corresponding to a standard steering property and a sports mode (second control mode) corresponding to a smaller steering assist force and hence a heavier steering effort. A normal map is selected for the normal mode, and a sports map is selected for the sports mode in each instance.

The switch over between the normal mode and the sports mode can be accomplished by the vehicle operator operating a mode selection switch 15. The mode selection switch 15 is placed near the vehicle occupant's seat such as on the steering wheel and the shift lever for the vehicle operator to operate while the vehicle is in motion. It is also possible to cause the control modes to be selected in response to the operation of the shift lever for selecting the shift position of the automatic transmission system, for instance, instead of providing the manually operated mode selection switch 15.

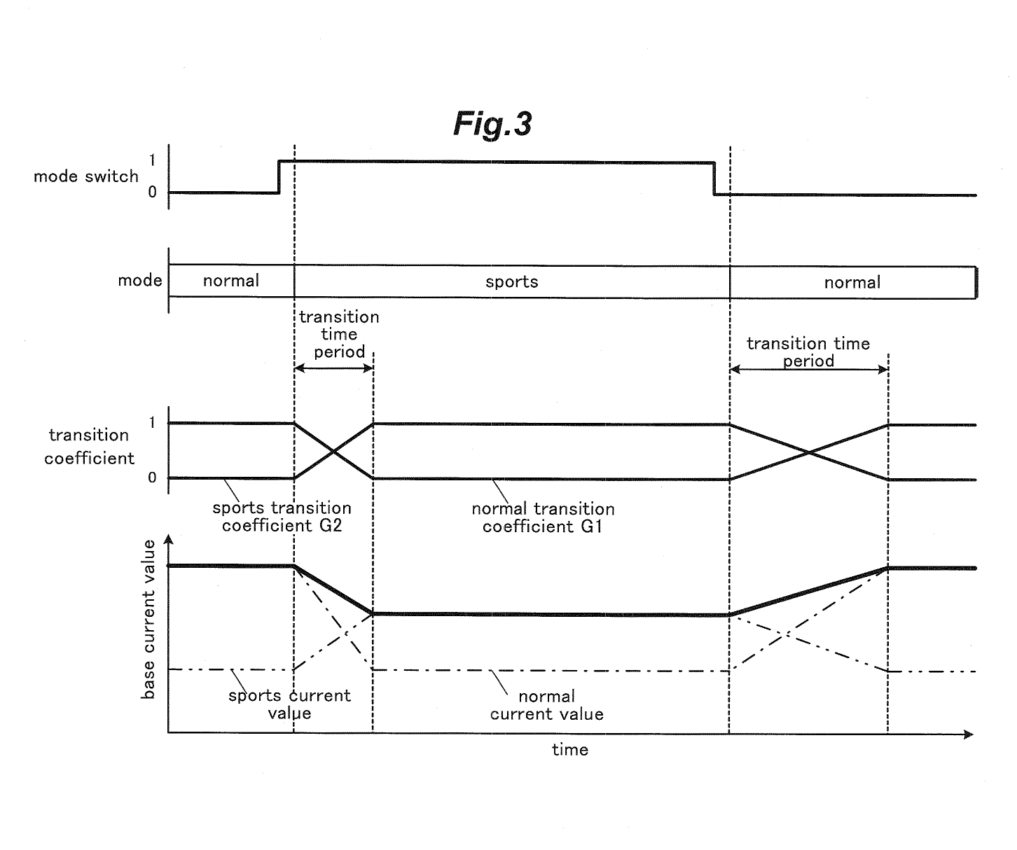

In particular, as shown in FIG. 3, when switching the control modes (between the sports mode and the normal mode), the current value based on the map corresponding to the preceding control mode is gradually changed to the current value based on the map corresponding to the following control mode, and the transition time period during which the current value is gradually changed may be selected depending on the controls modes that precede and follow the transition.

More specifically, the transition time period (1.5 seconds, for instance) for the transition from the sports mode to the normal mode is longer than the transition time period (0.5 seconds, for instance) for the transition from the normal mode to the sports mode.

The current value during the transition time period is computed by weighting the normal current value and the sports current value obtained by looking up the normal map and the sports map with a normal transition coefficient G1 and a sports transition coefficient G2 (0≦G1≦1, 0≦G2≦1, G1+G2=1), respectively, which may be considered to be similar to the weighting coefficients in weighted averaging.

During the transition time period from the normal mode to the sports mode, the normal transition coefficient G1 is progressively decreased while the sports transition coefficient G2 is progressively increased. Conversely, during the transition time period from the sports mode to the normal mode, the normal transition coefficient G1 is progressively increased while the sports transition coefficient G2 is progressively decreased.

FIG. 3 shows only the base current value obtained by the base current computing unit 31, and the inertia compensation current value obtained by the inertia compensation current computing unit 32 and the damping compensation current value obtained by the damping compensation current computing unit 33 are manipulated in a similar manner.

Preferably, immediately after the ignition switch is turned on, the normal mode is selected as the existing control mode. This switching of the control modes in the steering control device 21 may be performed in association with the control of the fuel injection system and the automatic transmission by the engine/transmission control device (FI/AT-ECU) so that the vehicle property may be changed in a harmonized manner. In this case, the control mode information shared by the different control devices should not be renewed until the transition is completed.

The normal map and the sports map are each configured to provide a control value (current value) from a state variable of the vehicle (such as the steering torque and the vehicle speed), and the information required for the map may be stored within a storage device of the steering control unit 21 in a suitable form such as a table and a formula, and may be suitably modified by using a compensation gain as required.

As discussed above, the transition from the normal mode to the sports mode takes place in a relatively short period of time so that the change in the steering impression occurs somewhat promptly. Therefore, the vehicle operator is enabled to clearly appreciate the change in the control modes. As the steering impression becomes heavier, the change in the steering impression does not cause an unfamiliar impression to the vehicle operator. In the case of the transition from the sports mode to the normal mode, as the transmission period is selected to be relatively long, the steering impression is prevented from becoming abruptly lighter, and the change in the steering impression does not cause an unfamiliar impression to the vehicle operator.

In the foregoing example, there were two selections of the control modes, the normal mode and the sports mode. However, it is also possible to provide three or more control modes. For instance, it is possible to add a super sports mode that provides an even heavier steering impression than the sports mode and/or an eco mode that shuts off the electric motor and provides no steering assist force with the aim of reducing power consumption.

Each of the base current computing unit 31, the inertia compensation current computing unit 32 and the damping compensation current computing unit 33 was provided with control maps for different control modes individually in the foregoing embodiment, but the present invention is not limited by this embodiment but may also provide that at least one of the base current computing unit 31, the inertia compensation current computing unit 32 and the damping compensation current computing unit 33 is configured to allow the switch over of the control maps. For instance, only the base current computing unit 31 may be configured to allow the switch over of the control maps.

The steering control unit 21 included the base current computing unit 31, the inertia compensation current computing unit 32 and the damping compensation current computing unit 33 in the foregoing embodiment, but other arrangements are also possible. For instance, either the inertia compensation current computing unit 32 or the damping compensation current computing unit 33 may be omitted. Also, the steering control unit 21 may include other forms of compensation current computing units, such as a compensation current computing unit based on a feed forward control of the steering torque. In such cases also, the control action may be executed by using different maps corresponding to different control modes.

Although the present invention has been described in terms of a preferred embodiment thereof, it is obvious to a person skilled in the art that various alterations and modifications are possible without departing from the scope of the present invention which is set forth in the appended claims. The contents of the original Japanese patent application on which the Paris Convention priority claim is made for the present application as well as the contents of the prior art references mentioned in this application are incorporated in this application by reference.

### GLOSSARY

1 electric power steering system
2 steering wheel
3 steering shaft
9 electric motor
15 mode selection switch
21 steering control unit
31 base current computing unit
32 inertia compensation current computing unit
34 adder
35 subtractor

1. An electric power steering system comprising an electric motor for producing a steering assist force for reducing a steering effort of a vehicle operator and a control unit for determining a control value for the electric motor, the control unit being configured to determine the control value by selecting a map representing a relationship between a vehicle state variable and a control value for each of a plurality of control modes, characterized in that:
when switching the control modes, the control unit gradually changes the control value from that obtained from a map corresponding to a preceding control mode to that obtained from a map corresponding to a following control mode, and a different time period of gradual transition from the preceding control mode to the following control mode is selected depending on the preceding and following control modes.

2. The electric power steering system according to claim 1, wherein the plurality of control modes include at least a first control mode corresponding to a standard steering property and a second control mode corresponding to a heavier steering property than the first control mode, the transition time period from the second control mode to the first control mode being longer than the transition time period from the first control mode to the second control mode.

3. The electric power steering system according to claim 1, wherein the control unit comprises computing units for computing a base control value based on a steering force of a vehicle operator and a vehicle speed, an inertia compensation value based on an inertia of an associated steering system and a damping compensation value based on a damping factor of the associated steering system, and is configured to determine the control value from computation results of these computing units, at least one of the computing units being configured to select a different map for each of a plurality of control modes.

4. The electric power steering system according to claim 2, wherein the control unit comprises computing units for computing a base control value based on a steering force of a vehicle operator and a vehicle speed, an inertia compensation value based on an inertia of an associated steering system and a damping compensation value based on a damping factor of the associated steering system, and is configured to determine the control value from computation results of these computing units, at least one of the computing units being configured to select a different map for each of a plurality of control modes.
